(19) United States
(12) Patent Application Publication
(10) Pub. No.: US 2013/0118678 A1
(43) Pub. Date: May 16, 2013

(54) Template Material and Method of Utilizing the Same to Attach Items to a Base Material

(71) Applicant: Brian Geers, Clovis, CA (US)

(72) Inventor: Brian Geers, Clovis, CA (US)

(21) Appl. No.: 13/295,024

(22) Filed: Nov. 11, 2011

(51) Int. Cl. B44C 1/18; B32B 37/12; B32B 33/00

(52) U.S. Cl. 156/230; 428/90; 156/60; 156/324

(57) ABSTRACT

A template material for use in attaching items, such as rhinestones and the like, to a base material, including the material of an article of clothing or an accessory item such as a hat, belt or purse. The template material comprises a flock material and a backing material, such as vinyl. A back surface of the flock is joined to the front surface of the vinyl to define a flock top surface and sticky bottom surface of the template material. A method of manufacturing the template material uses heat to join the flock to the vinyl. A method of utilizing the template material comprises cutting holes in the template material in a pattern, filling each hole with an item, removing the items from the template with a plastic sheet, placing the plastic sheet on a base material and applying heat to the items to attach them to the base material.

### CROSS-REFERENCE TO RELATED APPLICATIONS

None.

### STATEMENT REGARDING FEDERALLY SPONSORED RESEARCH

Not Applicable.

### REFERENCE TO A SEQUENCE LISTING, A TABLE OR A COMPUTER PROGRAM LISTING APPENDIX SUBMITTED ON A COMPACT DISC

Not Applicable.

### BACK GROUND OF THE INVENTION

A. Field of the Invention

The present invention relates generally to materials as a template and methods of utilizing such templates to attach one or more items, especially small decorative items such as rhinestones and the like, to a base material. In particular, the present invention relates to templates formed of a soft upper layer and a relatively stiffer layer that combined form a template material that is of a thickness that facilitates placement of the item on the base material, which can be clothing and other materials

B. Background

In general, the use of templates to facilitate placement or attachment of one or more items to a base material is well known in the art. In particular, the use of a template to attach items, particularly decorative items, to a base material is well known. One well known use of such templates is to attach a plurality of small decorative items, such as rhinestones and the like to a material that forms part of an article of clothing, such as a shirt, jacket, sweater, pants, socks and the like that can be worn by a person or an accessory item, such as a hat, purse, wallet or the like that are utilized by a person. In fact, many people enjoy wearing or having clothing and/or accessory items having rhinestones thereon that are applied to the clothing or accessory item, typically in a specific pattern or other arrangement. Although the person who owns the clothing or accessory item may apply the rhinestones himself or herself in a pattern created by himself/herself, many people purchase clothing and accessory items with the rhinestones already placed thereon in a pattern created by another person or purchase rhinestones in a ready to be applied pattern that they then place on the clothing or accessory item. As well known, the pattern can represent animals, plants, places, things or be purely a non-specific decorative pattern.

Commercially available rhinestones for use on clothing, accessory items and other items are typically made out of rock crystal, glass or acrylic and have an adhesive on the back side that is heat-activated to stick to the material, referred to herein as the base material, which makes up the clothing, accessory item or other item. As such, it is necessary to place each rhinestone on the base material with its heat-activated adhesive side positioned against the base material prior to applying the heat necessary to activate the rhinestone adhesive. Placing a rhinestone against the base material with the adhesive side facing up and the glass-like side against the base material will result in the rhinestone not attaching to the base material, leaving gaps in the intended design. As will be appreciated by persons familiar with using the typically small sized rhinestones, the fact that each rhinestone is very small makes application of a plurality of rhinestones to a base material in a specific pattern very difficult to achieve. Naturally, it is also necessary to maintain that pattern while applying heat to the rhinestones to cause them to attach to the base material. Because of the difficulties with handling and placing rhinestones on a base material, most people prefer to utilize a template that is configured in the pattern, or at least a portion thereof, which is desired for the rhinestones to be placed on the base material. As well known, the pattern in the template must be cut out of or into the template material in a manner which facilitates proper placement of the rhinestones on the base material while able to maintain the desired rhinestone pattern.

Presently, a variety of devices and methods are utilized to place rhinestones on a base material. One such device is called the Rhinestone Setter™ and is configured as an applicator wand that has different sized tips for different sizes of rhinestones. The user utilizes the wand to place one rhinestone at a time on the base material in the position he or she desires. Heat from the wand activates the adhesive on the rhinestone to stick the rhinestone to the base material. Other methods of installing rhinestones utilize machines, such as engravers, lasers and robotic machines, to form a reusable template that allows the user to place the entire pattern of rhinestones on the base material at the same time. The machine forms the desired pattern in the template material, which is usually a plastic, vinyl or like material, using software that controls the operation of the machine. Once the pattern is formed on the template material, the rhinestones are brushed across the surface of the plastic so that they fall into the cut out areas to place the rhinestones in the desired pattern with the heat activated adhesive facing down into the template. A sheet of transfer tape, which generally comprises a plastic sheet having a sticky surface on one side, is placed over the rhinestones with the sticky surface of the transfer tape placed against the upper surface of the rhinestones. The transfer tape is pulled up from the template to pull the rhinestones out of the template while maintaining them in the desired pattern. The rhinestones are then placed against the base material, with the adhesive side down, and a heat press is used to apply heat to the rhinestones and activate the adhesive. Although these machines have the advantage of producing reusable rhinestone templates, the machines are somewhat expensive to purchase and complicated to operate.

What is needed is a new template material that can be utilized to form a template that is used to apply a pattern of rhinestones to a base material, such as an article of clothing or an accessory item, and a method of utilizing that template material to apply the rhinestones to the base material. The template material should be configured so as to not require the use of expensive and difficult to operate machines to form the desired pattern in the template material. The template material should also be configured to allow the user to easily and efficiently place the rhinestones in the template to form the rhinestones in the desired pattern. The template material should also be configured to allow the user to easily transfer the pattern of rhinestones to the base material. The template material should produce a reusable template.

### SUMMARY OF THE INVENTION

The template material and method making and utilizing the same of the present invention provides the benefits and solves the problems identified above. That is to say, the present invention discloses an improved template material for use in attaching rhinestones and other items to a base material and an improved method of attaching these items to the base material. The improved template material allows the user to easily create a template having the desired pattern without the need to utilize the more expensive and complicated machines that are utilized in the prior art. The template material allows the user to easily and efficiently place the rhinestones and other items, including items referred to as nail heads and rhine studs, in the template to form these items in the desired pattern. Once the pattern is formed in the template material, the user can easily transfer the pattern of rhinestones or other decorative items to the base material, which may be an article of clothing, an accessory item or the like. A template formed by the improved template material is reusable and can be combined with other like configured templates to form new patterns.

The template material of the present invention generally comprises a flock material that is joined to a backing material. The flock material has a flock with a front surface and a back surface, with the back surface thereof having a heat activated first adhesive. The backing material has a body material with a front surface and a back surface, with the back surface having a second adhesive that is selected so as to removably stick to most surfaces. The back surface of the flock material is bonded to the front surface of the backing material to define a top surface comprising the flock and a bottom surface comprising the body material with the second adhesive thereon. In a preferred embodiment, the backing material is a vinyl material and the body material is vinyl. Typically, the template material will have a first protective sheet over the front surface of the flock and a second protective sheet over the second adhesive on the back surface of the vinyl.

A method of manufacturing a template material generally comprises the steps of directing the flock material and vinyl material into a joining machine, applying heat separately to each of the flock material and the vinyl material, positioning the back surface of the flock against the front surface of the vinyl with the first adhesive disposed therebetween so as to bind the flock to the vinyl, which will provide the template material with a top surface comprising the front surface of the flock and a bottom surface comprising the back surface of the vinyl and the second adhesive. The heat applied to the flock material being sufficient to activate the first adhesive and bind the flock to the vinyl.

A method of utilizing the template material generally comprises the steps of engaging the template material with a pattern cutting machine, cutting a plurality of holes through the template material with the cutting machine to form a pattern of such holes in the template material to create a template, positioning one item in each of the holes of the pattern, placing a sticky surface of a plastic sheet on the items in the pattern so as to stick the items to the sticky surface of the plastic sheet while maintaining the pattern of items, positioning the plastic sheet on the base material with the items and the sticky surface against the base material, applying heat to the plastic sheet to attach the items to the base material, and removing the plastic sheet from the base material to leave the items on the base material in the pattern. The cutting machine can be of the type that utilizes blades, lasers or other hole cutting apparatuses.

Accordingly, the primary aspect of the present invention is to provide an improved template material and method of attaching items to a base material that has the various advantages discussed above and which overcomes the disadvantages and limitations associated with prior template materials and method of applying such items to base materials.

It is an important aspect of the present invention to provide a template material that can be utilized to form a pattern thereon and then which can be utilized to attach items, typically decorative items such as rhinestones and the like, in that pattern to a base material, including articles of clothing, accessory items and the like.

It is also an important aspect of the present invention to provide an improved template material for use with rhinestones and like items that can have a pattern formed thereon for those items without the use of expensive and hard to operate machines.

It is also an important aspect of the present invention to provide a method of utilizing an improved template material to attach a pattern of items, typically decorative items such as rhinestones and the like, to a base material that allows the user to quickly, easily and efficiently apply the pattern of items to the base material.

It is also an important aspect of the present invention to provide a template material and method of utilizing the same to form a template that can be used with a wide variety of items, including rhinestones and other decorative items, to form a pattern of such items on an article of clothing, an accessory item or a variety of other items having a base material for receiving such design.

Another important aspect of the present invention is to provide a template material and method of attaching items such as rhinestones and the like to a base material that allows the user to reuse the template as desired and/or combine the template with other templates to form new patterns.

The above and other aspects and advantages of the present invention are explained in greater detail by reference to the attached figures and the description of the preferred embodiment which follows. As set forth herein, the present invention resides in the novel features of form, construction, mode of operation and combination of the above presently described and understood by the claims.

### BRIEF DESCRIPTION OF THE DRAWINGS

In the drawings which illustrate the preferred embodiments and the best modes presently contemplated for carrying out the present invention:

FIG. 1 is a side view of a template material configured according to one embodiment of the present invention;

FIG. 2 is an exploded side view of the template material of FIG. 1;

FIG. 3 is a side view of the template material of FIG. 1 shown with the flock and vinyl protective sheets thereof removed;

FIG. 4 is a flow chart showing the steps of one embodiment of a method of the present invention for manufacturing the template material of FIG. 1; and

FIG. 5 is a schematic showing one embodiment of a method of the present invention for utilizing the template material of FIG. 1 to attach rhinestones to an article of clothing.

### DETAILED DESCRIPTION OF THE PREFERRED EMBODIMENTS

With reference to the figures where like elements have been given like numerical designations to facilitate the reader's understanding of the present invention, the preferred embodiments of the present invention are set forth below. The enclosed text and drawings are merely illustrative of one or more preferred embodiments and, as such, disclose one or more different ways of configuring the present invention. Although specific components, materials, configurations and uses are illustrated, it should be understood that a number of variations to the components and to the configuration of those components described herein and in the accompanying figures can be made without changing the scope and function of the invention set forth herein. For instance, although the figures and description provided herein generally show and discuss certain specific materials to form the template material and use of the new template material to attach decorative items to a base material, those skilled in the art will understand that this is merely for purposes of simplifying this disclosure and that the present invention is not so limited. For instance, equivalent materials can be utilized to form the template material and the template material can be utilized to attach a wide variety of items, not just decorative items, to a base material.

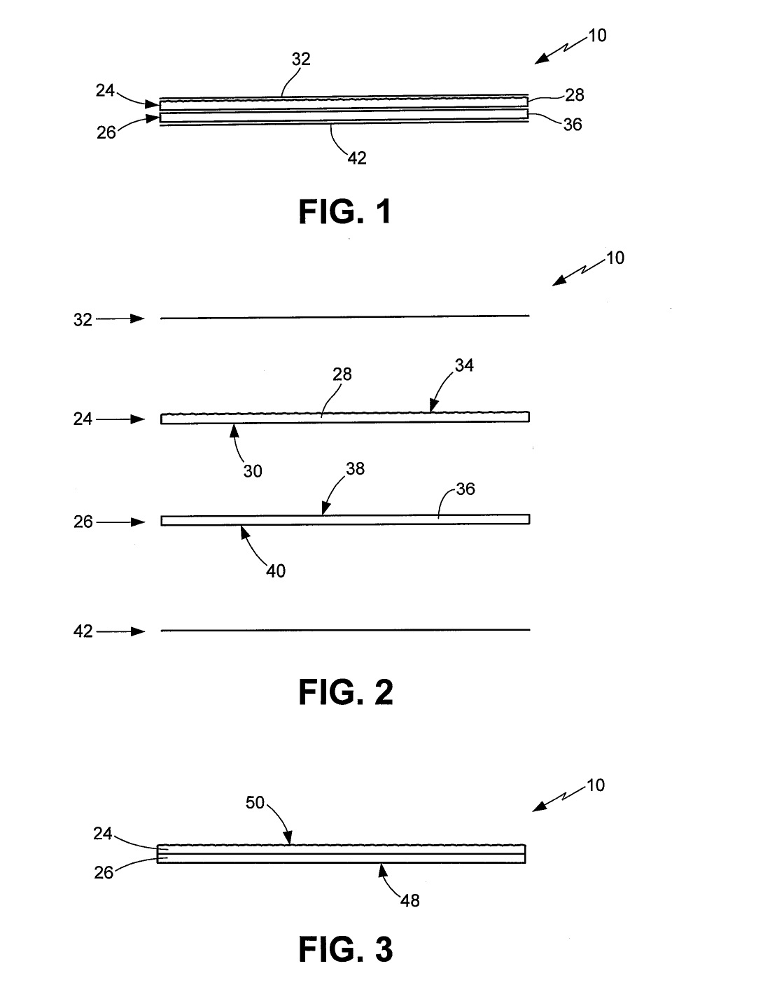

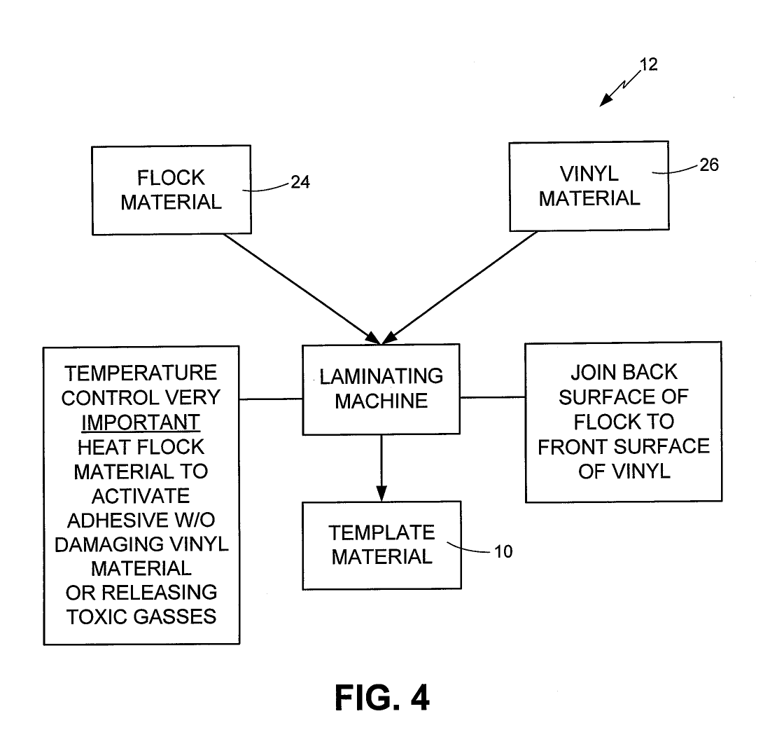

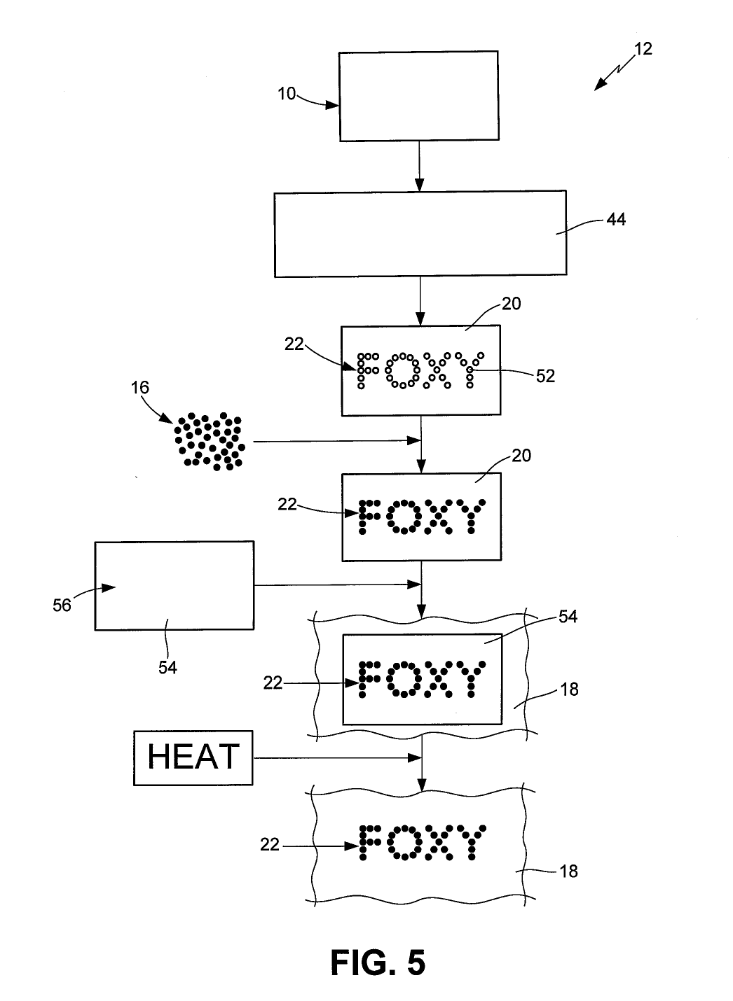

A template material that is configured pursuant to an embodiment of the present invention is shown generally as 10 in FIGS. 1 through 3. As set forth in more detail below and illustrated in FIGS. 4 and 5, the present invention includes a method of manufacturing the template material 10, referred to herein as the manufacturing method and identified generally as 12, and a method of utilizing the template material 10, referred to herein as the utilizing method and identified generally as 14, to attach one or more items 16 to a base material 18. As will be readily appreciated by those skilled in the art, template material 10 can be utilized, as set forth in the utilizing method 14, to attach rhinestones, nail heads, rhine studs and other decorative items 16 to an article of clothing, an accessory item or the like having a base material 18. As also will be readily appreciated by those skilled in the art, the template material 10 and the utilizing method 14 can also be utilized to attach a variety of similarly configured items 16, whether decorative or not, to virtually any type of base material 18. As a result, the use of rhinestones and clothing, or any other items 16 or base material 18, in this description is not intended to limit the present invention in any manner. In fact, those skilled in the art will understand that the template material 10 and the utilizing method 14 of the present invention can be utilized with a wide variety of other items 16 and/or base materials 18.

The template material 10 of FIGS. 1 through 3 is a combination of two existing materials that have not heretofore been combined in the manner shown and described herein. As set forth in more detail below, template material 10 is acted on to form a template 20 having a user selected pattern 22 thereon that is utilized to attach items 16 to a base material 18 in the form of the pattern 22, as summarized in the schematic of FIG. 5. In a preferred configuration of the present invention, the template material 10 comprises a flock material 24 and a backing material 26 that are joined together, as best shown in FIGS. 1 and 3 and according to the steps of the manufacturing method 12 summarized in FIG. 4, so they can be effectively and efficiently utilized as a template 20 having pattern 22 thereon, as shown in FIG. 5. The flock material 24 comprises the flock 28 itself, which has a back surface 30 that is covered, or at least substantially covered, with a heat activated adhesive, and a flock protective sheet 32 that removably covers the front surface 34 of the flock 28, as best shown in FIG. 2. The flock protective sheet 32 protects flock 28 from damage during transit and handling. The flock material 24 is commercially available. The backing material 26, which is also commercially available, comprises a body material 36 having a front surface 38 and a back surface 40. The back surface 40 is covered, or at least substantially covered, with an adhesive (not heat activated) that is protected until need for use by a removable protective sheet 42, as best shown in FIG. 2. In a preferred embodiment, the backing material 26 is a vinyl material and the body material 36 is vinyl and, therefore, are referred to as such hereinafter. As set forth in more detail below, flock material 24 and vinyl material 26 are combined in the manufacturing method 12 to form template material 10, best shown in FIGS. 1 and 3 and summarized in the flow chart of FIG. 4. As also set forth in more detail below and shown in the schematic of FIG. 5, template material 10 is placed in a pattern forming machine 44 to form template 20 having pattern 22 thereon.

As set forth above, the flock material 24 is commercially available and presently utilized in a variety of different decorative manners. The prior art flock material 24 has heat activated adhesive on the back surface 30 of the flock 28 that allows the flock 28 to be stuck against a variety of materials, including a base material 18. Typically, the flock material 24 is either hand cut or fed into a cutting-type machine to form flock material 24 in the desired shape, which may be a design, words, combination design/words or a random shape. The shaped flock material 24 is placed against the base material 18 and the heat is applied to the flock material 24 to stick the shaped flock material 24 to the base material 18. The flock protective sheet 32 is removed from the flock material 24, leaving the shaped flock 28 stuck to the base material 18. Presently, the flock material 24 has not been commonly utilized, if at all, for attaching items 16 to a base material 18 or at least not in an effective and efficient manner.

As also set forth above, vinyl material 26 is commercially available and presently utilized in a wide variety of different decorative and non-decorative manners, including signs and the like. The prior art vinyl material 26 has an adhesive, which typically is not of the heat-activated type, on the back surface 40 of the vinyl 36 that allows the vinyl 36 to be stuck against a variety of different surfaces, though not commonly base material 18. Typically, the vinyl material 26 is either hand cut or fed into a cutting-type machine to form vinyl material 26 into the desired shape, which may be a design, words, combination design/words or a random shape. The vinyl protective sheet 42 is removed from the back surface 40 of the shaped vinyl material 26 to expose the adhesive on back surface 40. The sticky back surface 40 is then placed against the desired surface, leaving the shaped vinyl 36 stuck against the surface. Presently, the vinyl material 26 is not utilized, or at least not commonly utilized, for attaching items 16 to a base material 18.

As summarized in FIG. 4, the manufacturing method 12 of the present invention joins the flock material 24 and the vinyl material 26 together to form the template material 10 of the present invention. Prior to the template material 10 of the present invention, the flock material 24 and vinyl material 26 have not been joined together, particularly not for use to attach items 16 to a base material 18. The flock material 24 and vinyl material 26 are jointly fed into a heat applying joining machine 46, such as a laminate or laminate-like machine, that applies heat to activate the heat activated adhesive on the back surface 30 of the flock 28. As summarized in FIG. 4, the flock material 24 and vinyl material 26 are placed into the joining machine 46 such that the back surface 30 of the flock 28 are in or will be placed in abutting relation to the front surface 38 of the vinyl 36. The heat from the joining machine 46 activates the adhesive on the back surface 30 and binds the flock material 24 to the vinyl material 26, forming the template material 10. The sticky back surface 40 of the vinyl 36 becomes a sticky bottom surface 48 for template material 10 and the front surface 34 of the flock 28 becomes the top surface 50 for template material 10, as best shown in FIG. 3 with the protective sheets 32/42 removed from template material 10. As set forth below and summarized in FIG. 5, these surfaces 48/50 of template material 10 are utilized to attach items 16 to base material 18. In a preferred embodiment, rolls of the flock material 24 and vinyl material 26 are fed into the joining machine 46 to form rolls or sheets of the template material 10. Once formed as template material 10, the flock 28, with flock protective sheet 32 thereon protecting flock 28, becomes the upper portion of template material 10 and the vinyl 36, with vinyl protective sheet 42 thereon covering the adhesive on back surface 40, becomes the lower portion of template material 10, as shown in FIG. 1.

As generally well known, flock material 24 is available with different thicknesses of flock 28 and vinyl material 26 is available in different thicknesses of vinyl 36. The thicknesses of these materials must be carefully selected to result in a template material 10 of the desired thickness. If the combination of flock 24 and vinyl 26 materials is too thick, the items 16 (particularly rhinestones and the like) will fall into the cut-out, as explained below, holes 52 that form pattern 22 in both the correct way (e.g., heat activated side facing downward) and the wrong way (e.g., with the heat activated side facing upward). If the material combination is too thin, then the holes 52 will not be deep enough to lock the items 16 into the pattern 22, which will result in the items 16 falling out before they can be applied to the base material 18. In fact, the thickness of the available flock material 24 is one of the problems why the flock material 24 is not usually utilized, if at all, for applying items 16 to a base material 18. Cutting holes 52 into the flock material 24 by itself results in a template that is too thin, resulting in the items 16 being knocked out of the holes 52 during the item application process, typically by being brushed away with a brush or the like. In addition, the vinyl material 26 improves the use of the flock material 24 by adding stiffness to the flock 28 that it normally does not have. Use of the vinyl material 26 by itself is or would be a problem because the plastic sheet 54 that is utilized to separate the items 16 from the template 20 in the desired pattern 22, as explained below, will stick to the vinyl 36 and make it difficult to separate plastic sheet 54 therefrom. In contrast, plastic sheet 54 easily separates from the flock 28 of template material 10, thereby facilitating placement of the items 16 in the desired pattern 22 on the base material 18.

The flock material 24 and the vinyl material 26 that is utilized in the manufacturing method 12 to form template material 10 must be selected with the attributes of template material 10 in mind. As stated above, the overall thickness of template material 10 is important. The present inventor has found that an overall thickness of 5 to 6 mils provides a desirable template material 10. The flock material 24 is available with different height fibers, which are heat pressed by the manufacture thereof to form the flock 28. In addition, the flock material 24 utilized for template material 10 must have or be able to receive an adhesive that will completely bond the flock 28 to the vinyl 36 of vinyl material 26. Although different types of adhesives can function to form the template material 10 and sheets of flock material 24 can be utilized to manufacture template material 10, preferably flock 28 will comprise a heat-activated adhesive on the back surface 30 thereof and the flock material 24 will also be available in rolls. Also, for purposes of forming the pattern 22, preferably the flock 28 of flock material 24 is of the type that can be effectively and efficiently cut with the blade(s) of a pattern cutting machine 44. An example flock material 24 that has been found to be useful for template material 10 is Siser® heat transfer rayon flock.

The vinyl material 26 utilized for template material 10 is also commercially available in different thicknesses. To achieve the overall desired thickness for template material 10, the present inventor has utilized a vinyl material 26 having a vinyl 36 with a thickness of 3.2 mils (approximately 4.0 mils with the adhesive thereon). Preferably, the vinyl 36 has a sticky back surface 40 with an adhesive that is of the type which allows the vinyl 36 to removably stick to a surface, which will allow the template 20 to be repositionable on surfaces, such as workstations and other templates, during the utilizing method 14 set forth in more detail below and shown in FIG. 5. The adhesive is preferably of the type that does not leave any residue on the surface once it is removed therefrom. The vinyl 36 must be made out of a material that provides a front surface 38 thereof that will bind to the heat-activated adhesive of flock material 24 to bind the flock 28 to the vinyl 36 to form the unified template material 10, as shown in FIGS. 1 and 3, in a manner that will not allow the two materials 28/36 to pull apart during use of template material 10. Although sheets of the vinyl material 36 can be utilized for manufacturing template material 10, preferably the vinyl material 36 will also be available in rolls. An example vinyl material 26 is the Scotchcal™ graphic film available from 3M.

The flock material 24 and the vinyl material 26 are joined together in a process that applies heat to the heat-activated adhesive on the back surface 30 of the flock 28 to bond it with the front surface 38 of the vinyl 36, as set forth in FIG. 4. In the embodiment shown in FIG. 4, the manufacturing method 12 utilizes a laminating machine as the joining machine 46. Sheets or rolls of flock material 24 and vinyl material 26 are jointly fed into the joining machine 46 such that the back surface 30 of the flock 28 is placed against, or will be placed against by the joining machine 46, the front surface 38 of the vinyl 36. Heat from the joining machine 46 activates the adhesive to effectively meld the two materials 28/36 together into the template material 10, best shown in FIG. 3. The temperature of the joining machine 46 needs to be carefully controlled to avoid damaging the flock 28 or vinyl 36. To best achieve the desired results, the joining machine 46 has two sets of heaters, one of which is utilized to heat the flock material 24 to a temperature that is sufficient to activate the adhesive on the back surface 30 of the flock 28 and the other of which is utilized to heat the vinyl material 26 to a point that is below the recommended level, which if exceeded may damage the vinyl 36 and/or release toxic gasses. Typically, the heater for the flock material 24 is heated to a much higher temperature than the heater for the vinyl material 26. In one embodiment, the flock material 24 requires a temperature of at least 300° F. to activate the adhesive thereon and the vinyl material 26 is limited to no more than 150° F. Other materials for the flock material 24 or the vinyl material 26 (or other backing material) may require different temperature settings.

A method of utilizing the template material 10 to apply items 16 to a base material 18 is shown as the utilizing method 14 in FIG. 5. In this method 14, the user obtains a sheet of template material 10 and removes the flock protective sheet 32 from the front surface 34 of flock 28 to expose the flock 28. Template material 10 is then fed or otherwise placed into the pattern forming machine 44 to form the pattern 22 thereon. The template material exits the pattern forming machine 44 as the template 20 having a plurality of holes 52 that define the user selected pattern 22. A plurality of items 16, which are shown as rhinestones in FIG. 5, are placed into the holes 52 with the heat-activated adhesive portion thereof directed downward in the holes 52 and the decorative portion thereof facing upward. In one embodiment, the items 16 are placed on top of template 20 and then, utilizing a brush or brush-like implement, they are spread across the pattern 22. The shape of the items 16 and the size and depth of holes 52, with the depth resulting from the thickness of the template material 10, causes the items 16 to naturally fall into the holes 52 in the proper alignment (e.g., that being the decorative side up) to fill all the holes 52 of pattern 22. The excess items 16 not needed to complete pattern 22 are brushed away to leave a clean item-filled pattern 22, as shown in FIG. 5. With each of the holes 52 filled with an item 16, the user places a plastic sheet 54, which is a heat resistant plastic film having a sticky surface 56 on one side thereof, over the item-filled pattern 22. The plastic sheet 54 is selected such that the adhesive on the sticky surface 56 will not stick or at least not stick very hard to the front surface 34 of flock 28 but will securely stick to the various items 16. The user then pulls up the plastic sheet 54, thereby separating the items 16 in the pattern 22 from the template 20. The plastic sheet 54 having the pattern 22 of items 16 thereon is placed on top of the base material 18 on which the items 16 are desired to be attached, such as an article of clothing as shown in FIG. 5, with the sticky surface 56 of the plastic sheet 54 against base material 18. Heat is applied, typically using a heat press or the like, to activate the heat-activated adhesive on the items 16 to bind the items 16, in the pattern 22, to the base material 18. Once the plastic sheet 54 cools sufficiently, the plastic sheet 54 is removed from the base material 18 to leave behind the items 16 thereon in the pattern 22, as shown in FIG. 5.

As set forth above, the method 14 of utilizing the template material 10 includes the step of using a pattern cutting machine 44 to place holes 54 in the desired pattern 22 in the template material 10 to form template 20. In a preferred embodiment, the holes 54 are formed using a cutter, such as a vinyl cutter, that has one or more blades that are computer controlled to cut out the holes 54 in the pattern 22. An example machine is the Roland® Camm-1 Servo GX-24 available from Roland ASD. In another embodiment, a laser machine is utilized to cut the holes 54 in the template material 10 (although such machines cannot be used with materials that may release toxins). With either machine 44, the holes 54 are cut or otherwise formed entirely through the template material 10. This is unlike other processes, such as the engraving process, which only forms holes that do not go entirely through the plastic which is used to form the pattern. Preferably, the materials 24/26 selected for the template material 10 are of the type that will not cause excessive wear or other damage to the blades of the pattern cutting machine 44, thereby controlling the cost of manufacturing the template 20 and attaching items 16 to the base material 18.

Advantages of the present invention include the ease of placing the items 16 in the holes 52 that form the pattern 22, the fact that the plastic sheet 54 does not stick, or at least does not significantly stick, to the flock 28 of template material 10 and the fact that the sticky bottom surface 48 of the template material 10 does not stick to the surfaces which are typically utilized as a workstation. Another advantage of the present invention is that the vinyl 36 of vinyl material 26 provides stiffness to the flock 28 that allows it to be beneficially utilized as a template 20 for attaching items 16 to a base material 18 by, in effect, locking the items 16 in the holes 52. Yet another advantage of the present invention is that the template 20, having pattern 22 made up of a plurality of holes 52, can be reused for as a whole or as a portion of another design. Because the templates 20 will not stick to each other, the present invention provides the ability to combine templates 20, something not possible with prior art materials and methods. When not in use, template 20 can be placed on a sheet of the same material that is used for the backing material (e.g., vinyl material 26) for storage so the bottom surface 48 of template material 10 will not fixedly stick to the backing/vinyl material 26.

While there are shown and described herein one or more specific embodiments of the invention, it will be readily apparent to those skilled in the art that the invention is not so limited, but is susceptible to various modifications and rearrangements in design and materials without departing from the spirit and scope of the invention. In particular, it should be noted that the present invention is subject to various modifications with regard to any dimensional relationships set forth herein, with regard to its assembly, size, shape and use and with regard to the materials used in its construction. For instance, there are a number of components described herein that can be replaced with equivalent functioning components to accomplish the objectives of the present invention.

What is claimed is:

1. A template material, comprising:
a flock material having a flock with a front surface and a back surface, said back surface comprising a first adhesive; and
a backing material having a body material with a front surface and a back surface, said back surface having a second adhesive,
wherein said back surface of said flock material is bonded to said front surface of said backing material with said first adhesive to define a top surface comprising said flock and a bottom surface comprising said body material with said second adhesive thereon.

2. The template material of claim 1, wherein said first adhesive is heat activated and heat was applied to bind said flock material to said backing material.

3. The template material of claim 1 further comprising a first protective sheet over said front surface of said flock and a second protective sheet over said second adhesive on said back surface of said body material.

4. The template material of claim 1, wherein said backing material is a vinyl material and said body material is a vinyl.

5. The template material of claim 4, wherein said first adhesive is heat activated and heat was applied to bind said back surface of said flock to said front surface of said vinyl.

6. The template material of claim 5 further comprising a first protective sheet over said front surface of said flock and a second protective sheet over said second adhesive on said back surface of said vinyl.

7. A method of manufacturing a template material, said method comprising the steps of:
a) directing a flock material and a backing material into a joining machine to combine said flock material and said backing material, said flock material having a flock with a front surface, a back surface and a first adhesive on said back surface thereof, said backing material having a body material with a front surface, a back surface and a second adhesive on said back surface thereof;
b) applying heat to each of said flock material and said backing material, wherein the heat applied to said flock material is sufficient to activate said first adhesive; and
c) positioning said back surface of said flock against said front surface of said body material with said first adhesive disposed therebetween so as to bind said flock to said body material and define a top surface and a bottom surface of said template material, said top surface comprising said front surface of said flock and said bottom surface comprising said back surface of said body material and said second adhesive.

8. The method of claim 7, further comprising a first protective sheet over said front surface of said flock and a second protective sheet over said second adhesive on said back surface of said body material.

9. The method of claim 7, wherein said backing material is a vinyl material and said body material is a vinyl.

10. The method of claim 9 further comprising a first protective sheet over said front surface of said flock and a second protective sheet over said second adhesive on said back surface of said vinyl.

11. The method of claim 9, wherein each of said flock material and said vinyl material are supplied in rolls that are fed into said joining machine.

12. A method of utilizing a template material having a flock material and a backing material to place a plurality of items on a base material, said method comprising the steps of:
a) selecting a template material with a top surface defined by a flock of said flock material and a bottom surface defined by a back surface of a body material of said backing material, said back surface having an adhesive thereon;
b) engaging said template material with a pattern cutting machine;
c) placing a plurality of holes in said template material with said cutting machine to form a pattern in said template material so as to define a template having said pattern;
d) positioning one of said items in each of said holes of said pattern;
e) placing a sticky surface of a plastic sheet on said items in said pattern so as to stick said items to said sticky surface of said plastic sheet while maintaining said pattern of said items;
f) positioning said plastic sheet on said base material with said items and said sticky surface against said base material;
g) applying heat to said plastic sheet so as to attach said items to said base material; and
h) removing said plastic sheet from said base material to leave said items on said base material in said pattern.

13. The method of claim 12, wherein said template material has a first protective sheet over a front surface of said flock and a second protective sheet over said adhesive on said back surface of said body material.

14. The method of claim 12, wherein said backing material is a vinyl material and said body material is a vinyl.

15. The method of claim 14, wherein said template material has a first protective sheet over said front surface of said flock and a second protective sheet over said adhesive on a back surface of said vinyl.

16. The method of claim 12, wherein said plurality of holes are cut entirely through said template material by said pattern cutting machine.
